(19) United States
(12) Patent Application Publication
(10) Pub. No.: US 2010/0036077 A1
(43) Pub. Date: Feb. 11, 2010

(54) Regioregular polymerization of alpha-olefins to produce polyethylene with a predominance of methyl substituents

(75) Inventors: Geoffrey W. Coates, Ithaca, NY (US); Anna Cherian, Ithaca, NY (US); Jeffrey M. Rose, Ithaca, NY (US)

Correspondence Address: CHOATE, HALL & STEWART LLP, TWO INTERNATIONAL PLACE, BOSTON, MA, 02110, US

(73) Assignee: Cornell Research Foundation, Inc., Ithaca, NY (US)

(21) Appl. No.: 11/607,015

(22) Filed: Dec. 1, 2006

Related U.S. Application Data
(60) Provisional application No. 60/749,029, filed on Dec. 12, 2005.

(51) Int. Cl. C08F 10/14

(52) U.S. Cl. 526/348.3; 526/348.2

(57) ABSTRACT

Regioregular polymers of C₄-C₂₀ alpha-olefins of Mₙ greater than 1000 g/mol, are obtained.

### CROSS-REFERENCE TO RELATED APPLICATION

This application claims the benefit of U.S. Provisional Patent Application No. 60/749,029, filed Dec. 12, 2005, the whole of which is incorporated herein by reference.

This invention was made at least in part with U.S. Government support under U.S. Army Research Laboratory and the U.S. Army Research Office under grant number DAAD 19-02-1-0275 MAP MURI and using facilities supported through the NSF MRSEC program (DMR-0079992). The government has certain rights in the invention.

### TECHNICAL FIELD

This invention is directed to regioregular polymerization of alpha olefin to produce substituted polyethylene.

### BACKGROUND OF THE INVENTION

The coordination-insertion polymerization of α-olefins using late transition metal catalysts typically occurs in a regioirrregular fashion leading to polymer containing a variety of enchainments, including but not limited to, 1,2 [—CH₂CH((CH₂)ₓ₋₃CH₃)—], ω,2 [—CH(CH₃)(CH₂)ₓ₋₂—], and ω,1 [—CH₂)—] enchainments, where x is equal to the number of carbons in the α-olefin. A random distribution of these and other enchainments can result in a polymer with undesirable properties.

In one case regioregular oligomerization of C₃-C₂₀ alpha olefins was carried out using a Ni⁰ aminobis(imino)phosphorane catalyst to obtain exclusively ω,2-enchainment. However, the products had Mₙ of only about 1000. See Mohring, V. M., et al. Angew Chem. Int. Ed. 24, 1001-1003 (1985) and Fink, G., Polym. Mater. Sci. Eng. 64, 47-48 (1991).

### SUMMARY OF THE INVENTION

It has been discovered herein that active transition metal catalyst is available to provide regioregular polymerization of C₄-C₂₀ alpha olefins resulting in product with Mₙ greater than 1,000 g/mol.

In one embodiment of the invention herein, denoted the first embodiment, there is provided a method for preparing a polymer comprising units (A)

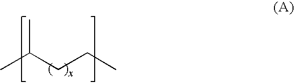

and none or one or both of units (B)

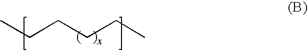

and units (C)

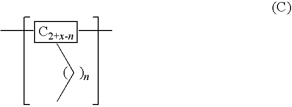

where x ranges from 1 to 17, n ranges from 1 to x+1, and Mₙ ranges from 1,500 g/mol to 1,500,000 g/mol, comprising the step of polymerizing one or more C₃₊ₓ alpha olefins in the presence of active transition metal complex capable of alkene insertion with the mole ratio of alpha-olefin to metal in the metal complex ranging from 20:1 to 100,000:1 in a non-polar non-protic solvent at a concentration of alpha olefin in the solvent ranging from 0.01 M to 12 M using a reaction temperature ranging from −80° C. to +150° C., to obtain polymer where there are more units (A) than units (B) and more units (A) than units (C).

In another embodiment herein, denoted the second embodiment, the invention is directed at a polymer comprising units (A) and none or one or both of units (B) and (C) as recited in the first embodiment herein where x ranges from 1 to 17, and Mₙ ranges from 1,500 g/mol to 1,500,000 g/mol, with more units (A) than units (B) and more units (A) than units (C).

In still another embodiment herein, denoted the third embodiment, the invention is directed to block copolymer with at least one block which is polymer of the second embodiment and method of making this.

The term “regioregular” as used herein means that the monomers are enchained such that the molecular structure (atomic connectivity) of the repeat units is the same in the resulting polymer.

The term “regioirregular” as used herein means that monomers are enchained such that the molecular structure (atomic connectivity) of the repeat units is different in the resulting polymer.

### DETAILED DESCRIPTION

We turn now to the first embodiment herein.

In one case, the polymer obtained contains 65 to 100% units (A), e.g. 65 to 96% or 98% units (A), 0 to 10% units (B) and 0 to 25% units (C).

In one case the polymer obtained has the structural formula

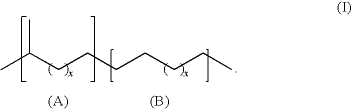

A preferred active transition metal complex capable of alkene insertion has the formula

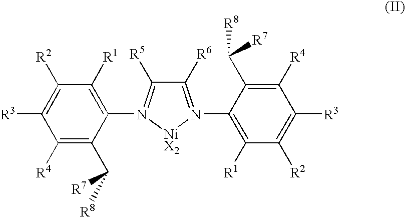

where X can be a halogen atom, an alkoxide, a carbon-containing group (such as a hydrocarbon), or a carboxylate where R¹, R², R³ and R⁴ can be the same or different, and are each a hydrogen atom, a carbon containing group, e.g. a hydrocarbon group, a halogen atom, a fluorocarbon group, a heterocyclic compound residue, an oxygen-containing group, a nitrogen-containing group, a boron-containing group, a sulfur-containing group, a phosphorus-containing group, a silicon-containing group, and two or more of them may be bonded to each other to form a ring or rings, and R⁵ and R⁶ are the same or different, and are each a hydrogen atom, a halogen atom, a fluorocarbon group, a heterocyclic compound residue, an oxygen-containing group, a nitrogen-containing group, a boron-containing group, a sulfur-containing group, a phosphorus-containing group, a carbon-containing group (such as a hydrocarbon), or a silicon-containing group, and they may be bonded to each other to form a ring or rings, and R⁷ and R⁸ are different and neither a hydrogen, and instead are each a halogen atom, a fluorocarbon group, a heterocyclic compound residue, an aromatic group, an oxygen-containing group, a nitrogen-containing group, a boron-containing group, a sulfur-containing group, a phosphorus-containing group, carbon-containing group (such as a hydrocarbon), or a silicon-containing group, and they may be bonded to each other to form a ring or rings. Each R¹, each R², each R³, each R⁴, each R⁷ and each R⁸ can be the same or different, that is both R's can be different in the same molecule, both R^{2s} can be different in the same molecule, etc. These complexes are made as described in U.S. application Ser. No. 11/508,333, the whole of which is incorporated herein by reference.

A very preferred complex for alkene insertion for use herein has the formula

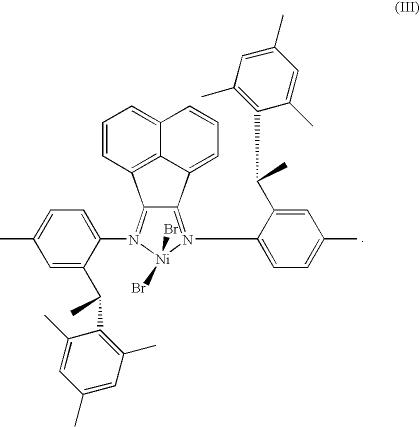

This complex is made as described in U.S. application Ser. No. 11/508,333 referred to above and incorporated herein by reference; and in Cheman, A. E., et al., J. Am. Chem. Soc. 127, 13770-13771 (2005), the whole of which is incorporated herein by reference.

The complexes of formulas (II) and (III) are preferably used together with cocatalyst which activates the complex to generate a nickel alkyl cation which enchains the olefin(s) to produce polymer, e.g. aluminum containing activator cocatalysts, e.g., MMAO-3A which has the approximate molecular formula [(CH₃)_{0.7}(isoC₄H₉)_{0.3}AlO]ₙ having the approximate molecular weight 70.7 (7 wt % in heptane, Akzo Nobel), PMAO-IP (polymethylaluminoxane—improved performance) (13 wt % in toluene, Akzo Nobel) and diethylaluminum chloride. The activator cocatalysts are used in cocatalyst metal complex nickel mole ratio, e.g. an Al/Ni mole ratio ranging from 5:1 to 2000:1, e.g., 100:1 to 500:1.

The non-polar non-protic solvent can be, for example, toluene, xylene, hexane or heptane and is preferably toluene.

The mole ratio of alpha olefin to metal in the metal complex is preferably 500:1 to 10,000:1.

The concentration of alpha olefin in the non-polar non-protic solvent preferably ranges from 0.1 M to 12 M.

The reaction temperature preferably ranges from −50° C. to +50° C.

The time of reaction in the Working Examples was 2 to 24 hours.

It was found that the higher the olefin concentration and the lower the reaction temperature, the greater the amount of units (A) compared to the amount of units (B) and the greater the amount of units (B) compared to units (C).

In one case, the first embodiment employs as monomer a mixture of C₃₊ₓ alpha olefin where x ranges from 1 to 17 and one or more C₂-C₂₀ alkenes which are different from the C₃₊ₓ alpha olefin.

We turn now to the second embodiment herein.

Exemplary PDI ranges from 1.05 to 2.

In one case of the second embodiment, x is 1 and there are no units (C).

In another case of the second embodiment, x is 2 and there are no units (B).

The polymer of the second embodiment preferably contains at least 30% units (A) and 0 to 10% units (B) and 0 to 25% units (C); e.g., at least 50% units (A) and greater than 1% units (B), e.g., at least 65 or 70% units (A) and greater than 2% units (B) and greater than 5% units (C). It is preferred for the polymer to contain less than 10% units (C).

In one important case, x was 3 (i.e., the starting alpha olefin was 1-hexene). In this case, Mₙ ranging from about 9,000 g/mol to about 250,000 g/mol and PDI ranging from 1.08 to 1.21 were obtained.

In other cases, x was 1, 2, 4 or 5 and Mₙ ranged from 30,000 g/mol to about 100,000 g/mol with PDI ranged from 1.06 to 1.26.

The polymers of the second embodiment have utility as substitutes for poly(ethylene-co-propylenes) and have uses as thermoplastic elastomers.

We turn now to the third embodiment. We turn to various methods for preparing block copolymers of the third embodiment and the products therefrom. The catalysts and cocatalysts employed are the same as for the first embodiment.

In one case the reaction conditions, e.g. temperature, monomer concentration, solvent polarity, of the first embodiment are varied during reaction so that a block copolymer is obtained comprising blocks each comprising units (A) and none or one or both units (B) and (C) and there are more units (A) than units (B) and more units (A) than units (C), with different proportions of (A), (B) and (C) in each block; in this case (B) and/or (C) must be present in at least one block and can be present in two or more blocks. The product may be described as a multi-block copolymer.

In another case, the monomers are a mixture of C₃₊ₓ alpha olefins where x ranges from 1 to 17 and one or more C₂-C₂₀ alkenes which are different from the C₃₊ₓ alpha olefins and reaction conditions e.g. temperature, monomer concentration, solvent polarity, of the first embodiment are varied during the polymerization to obtain blocks of each comprising units (A) and none or one or both of units (B) and none or one or both of units (C), with different proportions of (A), (B) and (C) in each block; in this case (B) and/or (C) must be present in at least one block.

In still another case, the monomers for the first embodiment are C₃₊ₓ alpha olefins where x ranges from 1 to 17 and one or more C₂-C₂₀ alkenes different from the C₃₊ₓ alpha olefin and/or mixtures of these added and/or polymerized at different times during the reaction to obtain at least one block comprising units (A) and none or one or both of units (B) and units (C) with more units (A) than units (B) and more units (A) than units (C). In this case, when the C₂-C₂₀ alkene is a C₄-C₂₀ alpha-olefin, the at least two blocks comprising units (A) and none or one or both of units (B) and (C) with more units (A) than units (B) and more units (A) than units (C), with different proportions of (A), (B) and (C) in each block; in this case (B) and/or (C) must be present in at least one block.

Mₙ, M_{w} and polydispersities (PDI, M_{w}/Mₙ) are determined by high temperature gel permeation chromatography (GPC). Analyses were performed with a Waters Alliance GPCV 2000 GPC equipped with a Waters DRI detector and viscometer. The column set (four Waters HT 6E and one Waters HT2) was eluted with 1,2,4-trichlorobenzene containing 0.01 wt % di-tert-butylhydroxytoluene (BHT) at 1.0 mL/min at 140° C. Data were calibrated using monomodal polyethylene standards (from Polymer Standards Service).

Elements of the invention and Working Examples are found in Rose, J. M., Cheman, A. E. and Coates, G. W., J. Am. Chem. Soc. 128, 4186-4187 (published on web on Mar. 11, 2006, hereinafter said JACS article, and pages S1-S19 of Supporting Information therefore, hereinafter said Supporting Information, the whole of both of which are incorporated herein by reference.

The invention is illustrated by the following working examples.

### Working Example I

Polymerization of 1-hexene in the presence of catalyst of structure III is set forth at pages S3, S4 and S5 of said Supporting Information.

### Working Example II

Polymerization of 1-hexene in the presence of catalyst of structure III is set forth at page S5 of said Supporting Information.

### Working Example III

Polymerization of 1-heptene in the presence of catalyst of structure III is set forth at page S5 of said Supporting Information.

### Working Example IV

Polymerization of 1-octene in the presence of catalyst of structure III is set forth at S5 of said Supporting Information.

### Working Example V

Polymerization of 1-butene in the presence of catalyst of structure III is set forth at pages S5 and S6 of said Supporting Information.

### Working Example VI

Conditions for and results for nine 1-hexene polymerizations are given in Table 1 of said JACS article.

### Working Example VII

Conditions for and results for polymerization five different alpha-olefins are given in Table 2 of said JACS article.

### Working Example VIII

In a 1-liter round bottom flask, under nitrogen, was added 1-pentene (100.0 mL), toluene (330 mL) and MMAO-3A (25 mmol). The mixture was cooled to −20° C. and after 10 minutes of equilibration, complex III (100 μmol) as a solution in CH₂Cl₂ (10 mL) was injected. After 2 hr an aliquot was taken from the reaction mixture and quenched with methanol and the flask was transferred to a 0° C. bath. After 5.1 h, a second aliquot was taken and quenched and the flask was transferred back to the −20° C. bath. The polymerization was quenched with MeOH 12 hr later after which the reaction mixture was poured into copious acidic MeOH. The polymer was filtered after stirring in acidic MeOH for approximately 12 h then dried in vacuo at 60° C. to give a mass of 16.61 g. The triblock has block Mₙ values of 62,400 g/mol, 40,400 g/mol, and 31,600 g/mol for blocks A, B, and C, respectively. For the overall polymer Mₙ=134,400 g/mol and PDI −1.15. For block A, the mole fraction ratio of each unit type (A:B:C) was 0.69:0.22:0.09; for B, the mole fraction ratio for each unit type (A:B:C) was 0.84:0.10:0.06. It had T_{g}=64.7° C. and Tₘ=100.1° C.

### Working Example IX

To a 12 oz. glass pressure reactor was added 1-pentene (11 mL), toluene (85 mL), and MMAO-7 (4 mmol). The reactor was cooled to −20° C. after which ethylene (10 psi) was added. Complex III (20 μmol) was injected as a solution in CH₂Cl₂ (2 mL). The polymerization was quenched with MeOH 25 min later, after which the reaction mixture was poured into copious acidic MeOH. The polymer was filtered after stirring in acidic MeOH for approximately 12 hrs then dried in vacuo at 60° C. to give a mass of 1.11 g. The copolymer had Mₙ—127,100 g/mol and PDI=1.08. It contained 73 mol % (—CH₂—) units, 23 mol % (—CH(CH₃)—) units, and 3 mol % (—CH(R)—) units where R=CₙH_{2N+1} and n>1. It had T_{g}=−52.8° C. and Tₘ=27.4° C.

### Working Example X

To a 12 oz. glass pressure reactor was added 1-pentene (63.5 mL), toluene (206 mL), and MMAO-3A (32.6 mmol). The reactor was cooled to −78° C. after which 1-butene (33.25 g) was condensed in. The reactor was then transferred to an ice bath and allowed to equilibrate for 20 min after which an overpressure of propylene (20 psi) was added. After equilibration for an additional 10 min, complex III (130 μmol) was injected as a solution in CH₂Cl₂ (8 mL). The polymerization was quenched with MeOH 3.1 hours later after which the reaction mixture was poured into copious acidic MeOH. The polymer was filtered after stirring in acidic MeOH for approximately 12 h, then dried in vacuo at 60° C. to give a mass of 12.5 g. The terpolymer had Mₙ=91,400 g/mol and PDI=1.23. It contained 78 mol % (—CH₂—) units, 20 mol % (—CH(CH₃)—) units, and 2 mol % (—CH(R)—) units where R=CₙH₂ₙ₊₁ and n>1.

### Working Example XI

To a 12 oz. glass pressure reactor was added toluene (100 mL) and MMAO-7 (6 mmol). The reactor was cooled to −20° C. after which ethylene (10 psi) was added. Complex III (30 μmol) was injected as a solution in 5 mL CH₂Cl₂ (8 mL). After 10 minutes, the reactor was vented and ethylene was removed in vacuo. 1-Pentene (30 mL) was then added. After 5 hr, 1-pentene was removed in vacuo, and ethylene (10 psi) was added. The polymerization was quenched with MeOH 10 minutes later, after which the reaction mixture was poured into copious acidic MeOH. The polymer was filtered after stirring in acidic MeOH for approximately 12 hours then dried in vacuo at 60° C. to give a mass of 1.11 g. The triblock had block Mₙ values of 47,600 g/mol, 33,800 g/mol, and 5,900 g/mol for blocks A, B, and C, respectively. For the overall polymer, Mₙ=87,300 g/mol and PDI −1.11. For block B, the mole fraction ratio of each unit type (A:B:C) was 0.97:0.03:0.0. Blocks (A) and (C) are linear polyethylene with less than one CH₃ group per 100 CH₂ groups. The triblock copolymer had T_{g}=63.3° C. and Tₘ=122.5° C.

### Working Example XII

An equimolar mixture of 1-pentene and 1-hexene in toluene is polymerized at minus 20° C. using complex III activated with methyaluminoxane to form block A. The temperature of the polymerization is then raised to 0° C. to form block B which differs in the proportions of units A, B, and C relative to block A. Lastly, the polymerization temperature is lowered back to −20° C. to form block C which differs in the proportions of units A, B, and C relative to blocks A and B.

### Working Example XII

A solution of 1-pentene in toluene is polymerized using complex III activated with methylaluminoxane to form block A. To the unreacted 1-pentene is added 1-hexene, and this mixture is then copolymerized to form block B which differs in the proportions of units A, B, and C relative to block A. Lastly, block C is formed when all of the 1-hexene is consumed in the polymerization. Block C differs in the proportions of units A, B, and C relative to blocks A and B.

### VARIATIONS

The foregoing description of the invention has been presented describing certain operable and preferred embodiments. It is not intended that the invention should be so limited since variations and modifications thereof will be obvious to those skilled in the art, all of which are within the spirit and scope of the invention.

1-7. (canceled)

8. A copolymer comprising units (A) and units selected from the group consisting of (B), (C), and a combination of units (B) and (C), where: 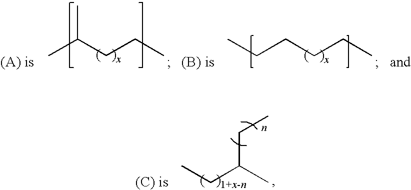
wherein:
x ranges from 2 to 17
n ranges from 1 to x+,
Mₙ ranges from 1,500 g/mol to 1,500,000 g/mol, and
there are more units (A) than units (B) and more units (A) than units (C).

9. The polymer of claim 8 where there are no units (C).

10. The polymer of claim 8 where there are no units (B).

11. The polymer of claim 8 containing from up to 10% units (B), up to 25% units (C), and at least 65% units (A).

12. (canceled)

13. The polymer of claim 11 containing at least 70% units (A).

14. The polymer of claim 8 where x is 2, 3, 4 or 5.

15. The polymer of claim 8 where x is 3.

16. A block copolymer wherein at least one block in the block copolymer is a polymer as described in claim 8.

17-26. (canceled)

27. The polymer of claim 9 where x is 2.

28. The polymer of claim 10 where x is 2.

29-31. (canceled)
